(19) United States
(12) Patent Application Publication
(10) Pub. No.: US 2025/0286077 A1
(43) Pub. Date: Sep. 11, 2025

(54) CURRENT COLLECTOR, AND PREPARATION METHOD THEREFOR AND APPLICATION THEREOF

(71) Applicant: YANGZHOU NANOPORE INNOVATIVE MATERIALS TECHNOLOGY LTD, Yangzhou (CN)

(72) Inventors: Gaoyang ZHOU, Yangzhou (CN); Xuefa LI, Yangzhou (CN); Guoping ZHANG, Yangzhou (CN)

(21) Appl. No.: 18/861,201

(22) PCT Filed: May 4, 2023
(86) PCT No.: PCT/CN2023/091984

§ 371 Date: Oct. 28, 2024

(30) Foreign Application Priority Data
Apr. 29, 2022 (CN) 202210464617.3
May 27, 2022 (WO) PCT/CN2022/095479

(51) Int. Cl. H01M 4/66; H01M 4/02

(52) U.S. Cl. CPC H01M 4/667; H01M 4/661; H01M 2004/021

(57) ABSTRACT

The present application relates to the technical field of batteries, and in particular, to a current collector, and a preparation method therefor and an application thereof the current collector includes a fiber base layer, in which a first bonding layer and a second bonding layer are respectively arranged on surfaces on two sides of the fiber base layer, a first metal layer and a second metal layer are respectively arranged on the surfaces of the first bonding layer and the second bonding layer away from the fiber base layer, and material composition of the fiber base includes the following components in parts by weight. Based on this, the current collector provided according to the present application can prevent a metal layer from peeling off while realizing the light weight of a battery.

### TECHNICAL FIELD

The present application relates to the technical field of batteries, and in particular, to a current collector, and a preparation method therefor and an application thereof.

### BACKGROUND

Nowadays, the current collectors for positive and negative electrodes of lithium-ion batteries basically adopt/employ pure copper foil as the negative current collector and pure aluminum foil as the positive current collector, which leads to the total mass of positive and negative current collectors being relatively heavy, accounting for about 15% to 20% of the total mass of the battery. Thinning the positive and negative current collectors allows the battery weight to be reduced so as to improve the energy density. However, nowadays, the pure aluminum foil is generally made by conventional calendering equipment, with a thinnest mass-production thickness of about 8 μm, and the pure copper foil is generally electrolytic copper material, which is precipitated and extruded by cathode rolls, with the thinnest mass-production thickness of about 6 μm. Limited by the current technology and equipment, it is difficult to further reduce the thickness of a copper foil or an aluminum foil. In addition, after copper and aluminum are formed into foils, the strength thereof is reduced, resulting in a reduction in processing performance and difficulty in further thinning.

At present, there are also studies on depositing aluminum or copper on a plastic film (such as a polyethylene terephthalate (PET) film, a polyvinyltoluene (PVT) film, and a polypropylene (PP) film) by physical or chemical deposition technology as a current collector to reduce battery weight, improve energy density, reduce cost and realize the light weight of a battery. However, the plastic film used has a relatively high ductility and is easily deformed. Moreover, in order to better achieve the conductivity comparable with the conventional foil, it is usually necessary to increase a deposition thickness of the copper layer or the aluminum layer to about 2 μm, and an increase in the thickness of the copper layer or the aluminum layer tends to cause the copper layer or the aluminum layer to be peeled off.

### SUMMARY

Based on this, in the present application, provided herein are a current collector that can prevent a metal layer from peeling off while realizing the light weight of a battery, and a preparation method therefor and an application thereof.

In order to achieve the above object of the present application, the following technical solutions are adopted.

In an aspect of the present application, provided herein is a current collector, including a fiber base layer. A first bonding layer and a second bonding layer are respectively arranged on surfaces on two sides of the fiber base layer, a first metal layer and a second metal layer are respectively arranged on the surfaces of the first bonding layer and the second bonding layer away from the fiber base layer, and material composition of the fiber base includes the following components in parts by weight:
50-120 parts of composite fibers, 4.1-19 parts of inorganic fillers and an auxiliary agent, in which the composite fibers include organic fibers and inorganic fibers.

Optionally, according to the aforementioned current collector, a mass ratio of the organic fibers to the inorganic fibers is in a range of (70-99.9):(0.1-30).

Optionally, according to the aforementioned current collector, a mass ratio of the organic fibers to the inorganic fibers is in a range of (90-99.9):(0.1-10).

Optionally, according to the aforementioned current collector, the inorganic fillers include one or more selected from calcium carbonate, borax and nano-silicon dioxide.

Optionally, according to the aforementioned current collector, the organic fibers include one or more selected from polyethylene terephthalate fibers, polybutylene terephthalate fibers, polyethylene naphthalate fibers, polypropyl carbamate fibers, polyurethane fibers, polycaprolactone fibers, nylon 6, nylon 66, polyimide fibers, polyacrylonitrile fibers, polyoxyethylene fibers, polyvinyl alcohol fibers, polyvinyl chloride fibers, polyvinylpyrrolidone fibers, cellulose acetate, ethyl cyanoethyl cellulose, polyaniline fibers, and polybenzoimidazole fibers.

Optionally, according to the aforementioned current collector, the inorganic fibers include one or more selected from graphene fibers, carbon fibers, glass fibers, ceramic fibers, metal oxide nanofibers, and silicon dioxide nanofibers.

Optionally, according to the aforementioned current collector, the auxiliary agent includes one or more selected from a dispersant, a thickener, an emulsifier and a binder;

The dispersant includes one or more selected from polyacrylamide, polyvinyl alcohol, sodium citrate and sodium silicon dioxidete;

The thickener includes one or more selected from sodium hydroxypropyl methylcellulose, sodium hydroxyethyl methylcellulose, sodium carboxymethylcellulose, sodium methylcellulose and sodium alginate;

The emulsifier includes one or more selected from glyceryl monostearate, polyoxyethylene ether and sodium lauryl sulfate; and

The binder includes sodium carboxymethylcellulose and/or polyvinyl alcohol.

Optionally, according to the aforementioned current collector, the amount of the auxiliary agent added to the fiber base layer is 8.1-28 parts by weight. In the auxiliary agent, the dispersant is 2.5-9 parts by weight, the thickener is 3-8 parts by weight, the emulsifier is 0.1-2 parts by weight, and the binder is 2.5-9 parts by weight.

Optionally, according to the aforementioned current collector, a first antioxidant layer and a second antioxidant layer are further included therein. The first antioxidant layer is located on a surface of the first metal layer away from the first bonding layer, the second antioxidant layer is located on a surface of the second metal layer away from the second bonding layer.

Optionally, according to the aforementioned current collector, the material of the first bonding layer and the second bonding layer is each independently selected from Ni, Zn, Fe, Gr, SiO₂, Al₂O₃, Fe₂O₃, and Si₃N₄.

Optionally, according to the aforementioned current collector, the material of the first metal layer and the second metal layer is each independently selected from Al, Cu, and Zn.

Optionally, according to the aforementioned current collector, the material of the first antioxidant layer and the second antioxidant layer is each independently selected from Al, Fe, Ni, Zn, Gr, Fe₂O₃, Al₂O₃, SiC, and Si₃N₄.

Optionally, according to the aforementioned current collector, a thickness of the fiber base layer is in a range of 2 μm to 8 μm.

Optionally, according to the aforementioned current collector, a thickness of the first metal layer and the second metal layer is each independently in a range of 10 nm to 200 nm.

Optionally, according to the aforementioned current collector, the thickness of the first metal layer and the second metal layer is each independently in a range of 100 nm to 2000 nm.

Optionally, according to the aforementioned current collector, the thickness of the first antioxidant layer and the second antioxidant layer is each independently in a range of 10 nm to 100 nm.

Optionally, according to the aforementioned current collector, the material of at least one of the first bonding layer and the second bonding layer is Fe, and the inorganic fibers comprise one or both of graphene fibers and carbon fibers.

Optionally, according to the aforementioned current collector, said inorganic fibers are selected from metal oxide nanofibers, the material of the first bonding layer and the second bonding layer is each independently selected from metal and metallic oxides.

Optionally, according to the aforementioned current collector, said inorganic fibers are one or more selected from graphene fibers, carbon fibers, glass fibers, ceramic fibers, and silicon dioxide nanofibers, and the material of the first bonding layer and the second bonding layer is each independently selected from non-metallic oxides and non-metallic nitrides.

In an aspect of the present application, further provided herein is a preparation method of a current collector as described above, including following steps:
Mixing the composite fibers, the inorganic fillers and the auxiliary agent and then rolling them into shape to prepare the fiber base layer;
Forming the first bonding layer and the second bonding layer on two sides of the fiber base layer, respectively; and
Forming the first metal layer and the second metal layer on sides of the first bonding layer and the second bonding layer away from the fiber base layer, respectively.

In another aspect of the present application, further provided herein is an electrode plate, including the aforementioned current collector and an electrode active material layer on a surface of the current collector.

In yet another aspect of the present application, provided herein is a battery cell, including the aforementioned electrode plate.

In an aspect of the present application, provided herein is a battery set, including a plurality of the aforementioned battery cells.

In yet another aspect of the present application, provided herein is an electrical device, including the aforementioned battery cell or the aforementioned battery set.

The fiber base layer has a lower ductility, and is not easily deformed. Moreover, the surfaces of the fiber base also do not need to be perforated, and achieve good bonding between the first metal layer and the second metal layer through the first bonding layer and the second bonding layer, and thereby prevent the first metal layer and the second metal layer from peeling off, solving the problem of reduced or lost battery performance due to the peeling of the first metal layer and the second metal layer. In addition, the fiber base layer allows the weight of the current collector to be reduced, thereby reducing the total weight of the battery, and improving the energy density thereof. Moreover, use of fiber base layer facilitates the infiltration of current collector with electrolyte, thus improving the efficiency of the battery liquid injection process, increasing the rate performance of the battery, and enhancing the stability of the battery.

In summary, the current collector provided according to the present application can prevent the metal plating layer from peeling off and reduce the manufacturing cost of the current collector and the battery, while realizing the light weight of the battery and improving the energy density of the battery.

### BRIEF DESCRIPTION OF THE DRAWINGS

In order to illustrate the technical solutions of the embodiments of the present application or of the prior art more clearly, the following drawings are briefly described as required in the context of the embodiments or the prior art. Apparently, the following drawings illustrate only some of the embodiments of the present application. Other relevant drawings may be obtained on the basis of the provided drawings without any creative effort by those skilled in the art.

FIG. 1 is a schematic structural diagram of a current collector prepared according to an embodiment of the present application.

Illustration of reference numerals: 100 fiber base, 200 first bonding layer, 300 first metal layer, 400 first antioxidant layer, 500 second bonding layer, 600 second metal layer, 700 second antioxidant layer.

### DETAILED DESCRIPTION

Reference to embodiments of the application will be provided in detail, one or more examples of which are described below. Each example is provided as an explanation rather than a limitation of the application. In fact, it will be apparent to those skilled in the art that various modifications and variations can be made to the application without departing from the scope or spirit of the application. For example, features illustrated or described as part of an embodiment may be used in another embodiment to produce a further embodiment.

Accordingly, it is intended that the application covers such modifications and variations falling within the scope of the appended claims and their equivalents. Other objects, features and aspects of the application are disclosed in or will be apparent from the following detailed description. It should be understood by those of ordinary skill in the art that this discussion is merely a description of exemplary examples and is not intended to limit the broader aspects of the application.

Unless otherwise defined, all terms including technical and scientific terms used herein have the same meaning as commonly understood by those skilled in the art to which the present application belongs. The terms used herein in the specification of the present application are used only to describe specific embodiments and are not intended as a limitation of the application. The term “and/or” as used herein includes any and all combinations of one or more of the relevant listed items.

The relatively heavy weight of the conventional current collector results in a relatively heavy total weight of the battery and relatively low energy density. In addition, a plastic film currently used to reduce the current collecting weight has a relatively high ductility, and is easy to deform, and the metal layer deposited thereon is easy to peel off, which makes it difficult to realize a substantial improvement in battery performance. To this end, a current collector is provided according to the present application to solve the above problems.

The present application relates to a current collector, including a fiber base layer. A first bonding layer and a second bonding layer are respectively arranged on surfaces on two sides of the fiber base layer, a first metal layer and a second metal layer are respectively arranged on the surfaces of the first bonding layer and the second bonding layer away from the fiber base layer, and material of the fiber base includes the following components in parts by weight:
50-120 parts of composite fibers, 4.1-19 parts of inorganic fillers and an auxiliary agent. The composite fibers include organic fibers and inorganic fibers.

The fiber base layer has a lower ductility, and is not easily deformed. Moreover, the surfaces of the fiber base also do not need to be perforated, and achieve good bonding between the first metal layer and the second metal layer through the first bonding layer and the second bonding layer, and thereby prevent the first metal layer and the second metal layer from peeling off, solving the problem of reduced or lost battery performance due to the peeling of the first metal layer and the second metal layer. In addition, the fiber base layer allows the weight of the current collector to be reduced, thereby reducing the total weight of the battery, and improving the energy density thereof. Moreover, use of fiber base layer facilitates the infiltration of current collector with electrolyte, thus improving the efficiency of the battery liquid injection process, increasing the rate performance of the battery, and enhancing the stability of the battery.

In summary, the current collector provided according to the present application can prevent the metal plating layer from peeling off and reduce the manufacturing cost of the current collector and the battery, while realizing the light weight of the battery and improving the energy density of the battery.

In some embodiments, the composite fiber may be any value from 50 to 120 parts by weight, for example, 55 parts, 58 parts, 60 parts, 65 parts, 70 parts, 80 parts, 90 parts, 100 parts or 110 parts by weight.

In some embodiments, a mass ratio of the organic fibers to the inorganic fibers may be any value in a range of (70-99.9):(0.1-30). and may also be 80:20, 82:18, 85:15, 87:13, 90:10, 92:8, 95:5 or 98:2.

In some embodiments, the organic fibers may be any of the organic fibers commonly used in the art, which include, but are not limited to one or more selected from polyethylene terephthalate fibers, polybutylene terephthalate fibers, polyethylene naphthalate fibers, polypropyl carbamate fibers, polyurethane fibers, polycaprolactone fibers, nylon 6, nylon 66, polyimide fibers, polyacrylonitrile fibers, polyoxyethylene fibers, polyvinyl alcohol fibers, polyvinyl chloride fibers, polyvinylpyrrolidone fibers, cellulose acetate, ethyl cyanoethyl cellulose, polyaniline fibers, and polybenzoimidazole fibers. Preferably, the organic fibers are one or more of nylon 6, nylon 66, polyimide fibers, and polyacrylonitrile fibers.

In some embodiments, the inorganic fibers may also be any of the inorganic fibers known in the art, which include, but not limited to one or more selected from graphene fibers, carbon fibers, glass fibers, ceramic fibers, metal oxide nanofibers, and silicon dioxide nanofibers. Preferably, the inorganic fibers are metal oxide nanofibers. The metal oxide nanofibers include one or more selected from aluminum oxide nanofibers, zinc oxide nanofibers, zirconium oxide nanofibers, magnesium oxide nanofibers, titanium dioxide nanofibers, and tin oxide nanofibers. The graphene fibers are a fibrous material composed of graphene monolayer units.

In some embodiments, the inorganic fillers include one or more selected from calcium carbonate, borax and nano-silicon dioxide. The mechanical properties and heat resistance of the fiber base can be improved by adding the inorganic fillers. Preferably, the inorganic fillers include calcium carbonate, borax and nano-silicon dioxide.

In some embodiments, in the inorganic fillers, calcium carbonate is 2-8 parts by weight, borax is 2-10 parts by weight, and nano-silicon dioxide is 0.1-1 parts by weight.

In some embodiments, the auxiliary agent may include one or more selected from a dispersant, a thickener, an emulsifier and a binder. The dispersant may be one or more selected from polyacrylamide, polyvinyl alcohol, sodium citrate and sodium silicon dioxidete. The thickener may be one or more selected from sodium hydroxypropyl methylcellulose, sodium hydroxyethyl methylcellulose, sodium carboxymethylcellulose, sodium methylcellulose and sodium alginate. The emulsifier may be one or more selected from glyceryl monostearate, polyoxyethylene ether and sodium lauryl sulfate. The binder may be sodium carboxymethylcellulose and/or polyvinyl alcohol.

In some embodiments, the amount of the auxiliary agent added into the fiber base layer may be 8.1-28 parts by weight. In the auxiliary agent, the dispersant may be 2.5-9 parts by weight, the thickener may be 3-8 parts by weight, the emulsifier may be 0.1-2 parts by weight, and the binder may be 2.5-9 parts by weight.

In some embodiments, a thickness of the fiber base layer may be any value from 2 μm to 8 μm, for example, 2.5 μm, 4 μm, 5.5 μm, 6 μm or 7 μm.

In some embodiments, the tensile elongation of the fiber base layer at the compaction density of 4 g/cm³ to 4.1 g/cm³ is in a range of 0.2% to 0.4%, which is much lower than that of the conventional copper foil or aluminum foil (>0.6%), whereby the elongation of the current collector prepared is lower and less prone to deformation.

In some embodiments, a surface of the fiber base layer may or may not have a porous structure. When it has a porous structure, the average pore diameter may be in a range of 5 nm to 500 nm, and the porosity may be in a range of 0.1% to 50%.

In some embodiments, a thickness of the first metal layer and the second metal layer may each independently be any value from 10 nm to 200 nm, for example, 30 nm, 50 nm, 100 nm, 130 nm, 150 nm or 180 nm.

In some embodiments, the material of the first bonding layer and the second bonding layer may be each independently selected from metal and metallic compound, in which the metal may be Ni, Zn, Fe or Gr, and the metallic compound may be oxides and nitrides, for example, SiO₂, Al₂O₃, Fe₂O₃ or Si₃N₄. The non-metallic compound is further categorized into a compound containing metallic elements and a compound containing no metallic elements. The compound containing metallic elements mainly includes metal oxides, for example, Al₂O₃ or Fe₂O₃. The compound containing no metallic elements mainly includes non-metallic oxides and non-metallic nitrides, for example, SiO₂ or Si₃N₄.

In some embodiments, the inorganic fibers are selected from metal oxide nanofibers, the material of the first bonding layer and the second bonding layer is each independently selected from metal and metallic oxides.

In some embodiments, the inorganic fibers are selected from metal oxide nanofibers, the material of each of the first bonding layer and the second bonding layer is each independently selected from Ni and Fe₂O₃.

In some embodiments, the inorganic fibers are one or more selected from graphene fibers, carbon fibers, glass fibers, ceramic fibers, and silicon dioxide nanofibers, and the material of each of the first bonding layer and the second bonding layer is each independently selected from non-metallic oxides and non-metallic nitrides, for example, SiO₂ or Si₃N₄.

In some embodiments, the inorganic fibers are one or more selected from graphene fibers, carbon fibers, glass fibers, ceramic fibers, and silicon dioxide nanofibers, and the material of the first bonding layer and the second bonding layer is each independently selected from non-metallic oxides and non-metallic nitrides.

In some embodiments, the inorganic fibers are selected from of graphene fibers and silicon dioxide nanofibers, and the material of the first bonding layer and the second bonding layer is each independently selected from Ni, Zn, Fe, and Gr.

In some embodiments, the inorganic fibers are one or two selected from graphene fibers and carbon fibers, and the material of at least one of the first bonding layer and the second bonding layer are Fe.

In some embodiments, the thickness of the first metal layer and the second metal layer may each independently be any value from 100 nm to 2000 nm, for example, 150 nm, 200 nm, 300 nm, 500 nm, 800 nm, 1200 nm, 1500 nm or 1800 nm.

In some embodiments, the material of the first metal layer and the second metal layer may each be selected from Al, Cu, and Zn.

In some embodiments, the current collector further includes a first antioxidant layer and a second antioxidant layer. The first antioxidant layer is located on a surface of the first metal layer away from the first bonding layer, and the second antioxidant layer is located on a surface of the second metal layer away from the second bonding layer. The introduction of the antioxidant layer may prevent the first metal layer and the second metal layer from oxidizing, and may further prevent the first metal layer and the second metal layer from peeling off.

In some embodiments, the thickness of the first antioxidant layer and the second antioxidant layer may each independently be any value from 10 nm to 100 nm, for example, 20 nm, 50 nm, 70 nm or 90 nm.

In some embodiments, the material of the first antioxidant layer and the second antioxidant layer may each independently be metal, metallic oxides or non-metallic compounds. The metal may be Al, Fe, Ni, Zn or Gr, the metallic oxides may be Fe₂O₃ or Al₂O₃, and the non-metallic compounds may be carbides or nitrides, for example, SiC or Si₃N₄. Preferably, When the material of the first metal layer and the second metal layer are Cu, the material of the first antioxidant layer and the second antioxidant layer may each independently be Al, Fe, Ni, Zn, Fe₂O₃, Al₂O₃ or SiC; and when the material of the first metal layer and the second metal layer is Al, the material of the first antioxidant layer and the second antioxidant layer may each independently be Ni, Gr, Al₂O₃ or Si₃N₄.

In an aspect of the present application, provided herein is a preparation method for a current collector as described above, including following steps:
Mixing the composite fibers, the inorganic fillers and the auxiliary agent and then rolling them into shape to prepare the fiber base layer;
Forming the first bonding layer and the second bonding layer on two sides of the fiber base layer, respectively; and
Forming the first metal layer and the second metal layer on sides of the first bonding layer and the second bonding layer away from the fiber base layer, respectively.

In some embodiments, the specific step of preparing the fiber base layer may include mixing the composite fibers, the inorganic fillers, and the auxiliary agent, laying them into a mesh-like, then hot-rolling, and drying into shape.

In some embodiments, a method of forming the first bonding layer, the second bonding layer, the first metal layer, and the second metal layer may be any method known in the art, such as vacuum vapor deposition.

In another aspect of the present application, further provided herein is an electrode plate, including the aforementioned current collector and an electrode active material layer on a surface of the current collector.

In yet another aspect of the present application, provided herein is a battery cell, including the aforementioned electrode plate.

In an aspect of the present application, provided herein is a battery set, including a plurality of the aforementioned battery cells.

In yet another aspect of the present application, provided herein is an electrical device, including the aforementioned battery cell or the aforementioned battery set.

The present application will be described in further detail below in conjunction with specific examples and comparative examples.

### Example 1

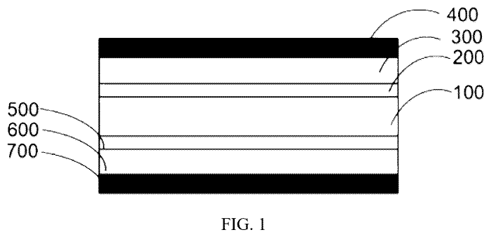

The schematic structural diagram of the current collector prepared in the present example is shown in FIG. 1. As shown in FIG. 1, the current collector included a fiber base layer 100. A first bonding layer 200 and a second bonding layer 500 were respectively provided on two sides of the fiber base layer 100, and a first metal layer 300 and a second metal layer 600 were respectively provided on sides of the first bonding layer 200 and the second bonding layer 500 away from the fiber base layer 100. A first antioxidant layer 400 and a second antioxidant layer 700 were provided on sides of the first metal layer 300 and the second metal layer 600 away from the first bonding layer 200 and the second bonding layer 500, respectively. Specific preparation steps of the current collector are as follows.

### Step 1): Preparation of the Fiber Base Layer 100

Nylon 6 and titanium dioxide nanofibers with a mass ratio of 98:2 were blended and melted, and then extruded to form composite fibers. 50 parts of composite fibers, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot-rolled and dried to prepare the fiber base layer 100 with a thickness of 6 μm.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were a nickel metal layer. A first metal layer 300 and a second metal layer 600 each with a thickness of 1000 nm were then deposited on the first bonding layer 200 and the second bonding layer 500, in which the first metal layer 300 and the second metal layer 600 were aluminum metal layers. Subsequently, a first antioxidant layer 400 and a second antioxidant layer 700 each with a thickness of 50 nm were continuously deposited on the first metal layer 300 and the second metal layer 600, in which the first antioxidant layer 400 and second antioxidant layer 700 were nickel metal layers, thus obtaining an aluminum current collector. The relevant performance tests were carried out and the test results were shown in Table 1.

### Example 2

The preparation method for the current collector and the current collector structure of this example were basically the same as those of Example 1, except that the first metal layer 300 and the second metal layer 600 in step 2) were copper metal layers, thereby preparing a copper current collector. The relevant performance tests were carried out and the test results were shown in Table 1.

### Example 3

The preparation method of the current collector and the current collector structure of this example were basically the same as those of Example 1, except that the fiber base layer 100 was formulated differently. Specific preparation steps of the current collector are as follows.

### Step 1): Preparation of the Fiber Base Layer 100

Nylon 6 and titanium dioxide nanofibers with a mass ratio of 98:2 were blended and melted, and then extruded to form composite fibers. 80 parts of composite fibers, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot-rolled and dried to prepare the fiber base layer 100 with a thickness of 6 m.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were a silicon dioxide layer. A first metal layer 300 and a second metal layer 600 each with a thickness of 1000 nm were then deposited on the first bonding layer 200 and the second bonding layer 500, in which the first metal layer 300 and the second metal layer 600 were aluminum metal layers. Subsequently, a first antioxidant layer 400 and a second antioxidant layer 700 each with a thickness of 50 nm were continuously deposited on the first metal layer 300 and the second metal layer 600, in which the first antioxidant layer 400 and second antioxidant layer 700 were Al₂O₃ layers, thus obtaining an aluminum current collector. The relevant performance tests were carried out and the test results were shown in Table 1.

### Example 4

The preparation method of the current collector and the current collector structure of this example were basically the same as those of Example 3, except that the first metal layer 300 and the second metal layer 600 in step 2) were a copper metal layer, and the first antioxidant layer 400 and the second antioxidant layer 700 were SiC layers, thereby preparing a copper current collector. The relevant performance tests were carried out and the test results were shown in Table 1.

### Example 5

The preparation method of the current collector and the current collector structure of this example were basically the same as those of Example 1, except that the fiber base layer 100 was formulated differently. Specific preparation steps of the current collector are as follows.

### Step 1): Preparation of the Fiber Base Layer 100

Polyimide fibers and glass fibers with a mass ratio of 98:2 were blended and melted, and then extruded to form composite fibers. 120 parts of composite fibers, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot rolled and dried to prepare the fiber base layer 100 with a thickness of 6 m.

### Step 2): Preparation of the Current Collector

A first bonding layer 200 and a second bonding layer 500 each with a thickness of 40 nm were respectively deposited on the upper and lower surfaces of the fiber base layer 100 prepared in step 1) by using the technique of vacuum vapor deposition, in which the first bonding layer 200 and the second bonding layer 500 are a nickel metal layer. A first metal layer 300 and a second metal layer 600 each with a thickness of 1000 nm were then deposited on the first bonding layer 200 and the second bonding layer 500, in which the first metal layer 300 and the second metal layer 600 were aluminum metal layers. Subsequently, a first antioxidant layer 400 and a second antioxidant layer 700 each with a thickness of 40 nm were continuously deposited on the first and second metal layers 300 and 600, in which the first antioxidant layer 400 and second antioxidant layers 700 were nickel metal layers, thus obtaining an aluminum current collector. The relevant performance tests were carried out and the test results were shown in Table 1.

### Example 6

The preparation method of the current collector and the current collector structure of this example were basically the same as those of Example 5, except that the first metal layer 300 and the second metal layer 600 in step 2) were copper metal layers, thereby preparing a copper current collector. The relevant performance tests were carried out and the test results were shown in Table 1.

### Example 7

The preparation method of the current collector and the current collector structure of this example were basically the same as those of Example 1, except that the fiber base layer 100 was formulated differently. Specific preparation steps of the current collector are as follows.

### Step 1): Preparation of the Fiber Base Layer 100

Polyacrylonitrile fibers and silicon dioxide nanofibers with a mass ratio of 85:15 were blended and melted, and then extruded to form composite fibers. 50 parts of composite fibers, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot rolled and dried to prepare the fiber base layer 100 with a thickness of 6 μm.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were a nickel metal layer. A first metal layer 300 and a second metal layer 600 each with a thickness of 1000 nm were then deposited on the first bonding layer 200 and the second bonding layer 500, in which the first metal layer 300 and the second metal layer 600 were aluminum metal layers. Subsequently, a first antioxidant layer 400 and a second antioxidant layer 700 each with a thickness of 50 nm were continuously deposited on the first metal layer 300 and the second metal layer 600, in which the first antioxidant layer 400 and second antioxidant layer 700 were nickel metal layers, thus obtaining an aluminum current collector. The relevant performance tests were carried out and the test results were shown in Table 1.

### Example 8

The preparation method of the current collector and the current collector structure of this example were basically the same as those of Example 7, except that the first bonding layer 200 and the second bonding layer 500 were made of different materials. Specific preparation steps of the current collector are as follows.

### Step 1): Preparation of the Fiber Base Layer 100

Polyacrylonitrile fibers and silicon dioxide nanofibers with a mass ratio of 85:15 were blended and melted, and then extruded to form composite fibers. 50 parts of composite fibers, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot rolled and dried to prepare the fiber base layer 100 with a thickness of 6 μm.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were a silicon dioxide layer. A first metal layer 300 and a second metal layer 600 each with a thickness of 1000 nm were then deposited on the first bonding layer 200 and the second bonding layer 500, in which the first metal layer 300 and the second metal layer 600 were aluminum metal layers. Subsequently, a first antioxidant layer 400 and a second antioxidant layer 700 each with a thickness of 50 nm were continuously deposited on the first metal layer 300 and the second metal layer 600, in which the first antioxidant layer 400 and second antioxidant layer 700 were nickel metal layers, thus obtaining an aluminum current collector. The relevant performance tests were carried out and the test results were shown in Table 1.

### Example 9

The preparation method of the current collector and the current collector structure of this example were basically the same as those of Example 6, except that the first bonding layer 200 and the second bonding layer 500 were made of different materials. Specific preparation steps of the current collector are as follows.

### Step 1): Preparation of the Fiber Base Layer 100

Polyimide fibers and glass fibers with a mass ratio of 98:2 were blended and melted, and then extruded to form composite fibers. 120 parts of composite fibers, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot rolled and dried to prepare the fiber base layer 100 with a thickness of 6 μm.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were SiO₂ layers. A first metal layer 300 and a second metal layer 600 each with a thickness of 1000 nm were then deposited on the first bonding layer 200 and the second bonding layer 500, in which the first metal layer 300 and the second metal layer 600 were copper metal layers. Subsequently, a first antioxidant layer 400 and a second antioxidant layer 700 each with a thickness of 40 nm were continuously deposited on the first metal layer 300 and the second metal layer 600, in which the first antioxidant layer 400 and second antioxidant layer 700 were nickel metal layers, thus obtaining a copper current collector. The relevant performance tests were carried out and the test results were shown in Table 1.

### Example 10

The preparation method of the current collector and the current collector structure of this comparative example were basically the same as those of Example 1, except that the first bonding layer 200 and the second bonding layer 500 were made of different materials. Specific preparation steps of the current collector are as follows.

### Step 1): Preparation of the Fiber Base Layer 100

Nylon 6 and titanium dioxide nanofibers with a mass ratio of 98:2 were blended and melted, and then extruded to form composite fibers. 50 parts of composite fibers, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot-rolled and dried to prepare the fiber base layer 100 with a thickness of 6 μm.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were a silicon dioxide layer. A first metal layer 300 and a second metal layer 600 each with a thickness of 1000 nm were then deposited on the first bonding layer 200 and the second bonding layer 500, in which the first metal layer 300 and the second metal layer 600 were aluminum metal layers. Subsequently, a first antioxidant layer 400 and a second antioxidant layer 700 each with a thickness of 50 nm were continuously deposited on the first metal layer 300 and the second metal layer 600, in which the first antioxidant layer 400 and second antioxidant layer 700 were nickel metal layers, thus obtaining an aluminum current collector. The relevant performance tests were carried out and the test results were shown in Table 1.

### Example 11

The preparation method of the current collector and the current collector structure of this comparative example were basically the same as those of Example 1, except that the inorganic fibers were selected from different materials, and the first bonding layer 200 and the second bonding layer 500 were made of different materials. Specific preparation steps of the current collector are as follows.

### Step 1): Preparation of the Fiber Base Layer 100

Nylon 6 and graphene fibers with a mass ratio of 98:2 were blended and melted, and then extruded to form composite fibers. 50 parts of composite fibers, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot rolled and dried to prepare the fiber base layer 100 with a thickness of 6 μm.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were ferrous metal layers. A first metal layer 300 and a second metal layer 600 each with a thickness of 1000 nm were then deposited on the first bonding layer 200 and the second bonding layer 500, in which the first metal layer 300 and the second metal layer 600 were aluminum metal layers. Subsequently, a first antioxidant layer 400 and a second antioxidant layer 700 each with a thickness of 50 nm were continuously deposited on the first metal layer 300 and the second metal layer 600, in which the first antioxidant layer 400 and second antioxidant layer 700 were nickel metal layers, thus obtaining an aluminum current collector. The relevant performance tests were carried out and the test results were shown in Table 1.

### Example 12

The preparation method of the current collector and the current collector structure of this comparative example were basically the same as those of Example 11, except that the first metal layer 300 and the second metal layer 600 in step 2) were copper metal layers, thereby preparing a copper current collector. Specific preparation steps of the current collector are as follows.

### Step 1): Preparation of the Fiber Base Layer 100

Nylon 6 and graphene fibers with a mass ratio of 98:2 were blended and melted, and then extruded to form composite fibers. 50 parts of composite fibers, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot rolled and dried to prepare the fiber base layer 100 with a thickness of 6 μm.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were ferrous metal layers. A first metal layer 300 and a second metal layer 600 each with a thickness of 1000 nm were then deposited on the first bonding layer 200 and the second bonding layer 500, in which the first metal layer 300 and the second metal layer 600 were copper metal layers. Subsequently, a first antioxidant layer 400 and a second antioxidant layer 700 each with a thickness of 50 nm were continuously deposited on the first and second metal layers 300 and 600, in which the first antioxidant layer 400 and second antioxidant layers 700 were nickel metal layers, thus obtaining a copper current collector. The relevant performance tests were carried out and the test results were shown in Table 1.

### Example 13

The preparation method of the current collector and the current collector structure of this comparative example were basically the same as those of Example 11, except that the inorganic fibers were selected from different materials. Specific preparation steps of the current collector are as follows.

### Step 1): Preparation of the Fiber Base Layer 100

Nylon 6 and carbon fibers with a mass ratio of 98:2 were blended and melted, and then extruded to form composite fibers. 50 parts of composite fibers, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot rolled and dried to prepare the fiber base layer 100 with a thickness of 6 μm.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were ferrous metal layers. A first metal layer 300 and a second metal layer 600 each with a thickness of 1000 nm were then deposited on the first bonding layer 200 and the second bonding layer 500, in which the first metal layer 300 and the second metal layer 600 were aluminum metal layers. Subsequently, a first antioxidant layer 400 and a second antioxidant layer 700 each with a thickness of 50 nm were continuously deposited on the first metal layer 300 and the second metal layer 600, in which the first antioxidant layer 400 and second antioxidant layer 700 were nickel metal layers, thus obtaining an aluminum current collector. The relevant performance tests were carried out and the test results were shown in Table 1.

### Example 14

The preparation method of the current collector and the current collector structure of this comparative example were basically the same as those of Example 12, except that the inorganic fibers were selected from different materials. Specific preparation steps of the current collector are as follows.

### Step 1): Preparation of the Fiber Base Layer 100

Nylon 6 and carbon fibers with a mass ratio of 98:2 were blended and melted, and then extruded to form composite fibers. 50 parts of composite fibers, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot rolled and dried to prepare the fiber base layer 100 with a thickness of 6 μm.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were ferrous metal layers. A first metal layer 300 and a second metal layer 600 each with a thickness of 1000 nm were then deposited on the first bonding layer 200 and the second bonding layer 500, in which the first metal layer 300 and the second metal layer 600 were copper metal layers. Subsequently, a first antioxidant layer 400 and a second antioxidant layer 700 each with a thickness of 50 nm were continuously deposited on the first and second metal layers 300 and 600, in which the first antioxidant layer 400 and second antioxidant layers 700 were nickel metal layers, thus obtaining a copper current collector. The relevant performance tests were carried out and the test results were shown in Table 1.

### Comparative Example 1

The preparation method of the current collector and the current collector structure of this comparative example were basically the same as those of Example 1, except that the fibers used in the fiber base layer 100 were only nylon 6. The specific steps are as follows.

### Step 1): Preparation of the Fiber Base Layer 100

50 parts of nylon 6, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot rolled and dried to prepare the fiber base layer 100 with a thickness of 6 μm.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were a nickel metal layer. A first metal layer 300 and a second metal layer 600 each with a thickness of 1000 nm were then deposited on the first bonding layer 200 and the second bonding layer 500, in which the first metal layer 300 and the second metal layer 600 were aluminum metal layers. Subsequently, a first antioxidant layer 400 and a second antioxidant layer 700 each with a thickness of 50 nm were continuously deposited on the first metal layer 300 and the second metal layer 600, in which the first antioxidant layer 400 and second antioxidant layer 700 were nickel metal layers, thus obtaining an aluminum current collector. The relevant performance tests were carried out and the test results were shown in Table 1.

### Comparative Example 2

The preparation method of the current collector and the current collector structure of this comparative example were basically the same as those of Comparative Example 1, except that the first metal layer 300 and the second metal layer 600 were copper metal layers. The specific steps are as follows.

### Step 1): Preparation of the Fiber Base Layer 100

50 parts of nylon 6, 3 parts of sodium methylcellulose, 3 parts of polyacrylamide, 0.5 parts of glyceryl monostearate, 2 parts of calcium carbonate, 5 parts of polyvinyl alcohol, 2 parts of borax and 0.2 parts of nano-silicon dioxide were mixed uniformly, laid uniformly into a mesh, and then hot rolled and dried to prepare the fiber base layer 100 with a thickness of 6 μm.

### Step 2): Preparation of the Current Collector

A first bonding layer 200 and a second bonding layer 500 each with a thickness of 50 nm were respectively deposited on the upper and lower surfaces of the fiber base layer 100 prepared in step 1) by using the technique of vacuum vapor deposition, in which the first bonding layer 200 and the second bonding layer 500 were a nickel metal layer. A first metal layer 300 and a second metal layer 600 each with a thickness of 1000 nm were then deposited on the first bonding layer 200 and the second bonding layer 500, in which the first metal layer 300 and the second metal layer 600 were copper metal layers. Subsequently, a first antioxidant layer 400 and a second antioxidant layer 700 each with a thickness of 50 nm were continuously deposited on the first metal layer 300 and the second metal layer 600, in which the first antioxidant layer 400 and second antioxidant layer 700 were nickel metal layers, thus obtaining an aluminum current collector. The relevant performance tests were carried out and the test results were shown in Table 1.

### Comparative Example 3

The preparation method of the current collector and the current collector structure of this comparative example were basically the same as those of Example 1, except that the mass ratio of nylon 6 to titanium dioxide nanofibers in the composite fibers was 60:40.

### Comparative Example 4

The preparation method of the current collector and the current collector structure of this comparative example were basically the same as those of Example 1, except that the first bonding layer and the second layer were not provided.

Test method for tensile elongation: an end of the fiber base layer is clamped in an upper clamping head of a tensile testing machine, an opposite end is clamped in a lower clamping head of the tensile testing machine and held on the same axis. The parameters of the testing machine such as specification, speed, unit are set, the stretching length and the load value of the sample are measured and recorded during the test process. The tensile elongation of the fiber base layer is calculated according to the test results. The tensile elongation is tested at a pressure density in a range of 4 g/cm³ to 4.1 g/cm³. The pressure density means a ratio of the tensile force applied on a sample to a cross sectional area of the sample. The test conditions are specified: a temperature from 20° C. to 25° C., and a relative humidity from 40% to 70%.

Test method for peeling force: an adhesive tape with a length of 11 cm is pasted on a steel plate, and then a current collector with a length of 10 cm is pasted on the adhesive tape. An adhesive tape with a length of 22 cm is pasted on the current collector, and the steel plate to is fixed on the peeling force testing machine. A chuck of a peeling force testing machine clamps a free end of the adhesive tape with the length of 22 cm after the adhesive tape with the length of 22 cm is bended into a U-shape, and then the peeling force testing machine is started to separate the metal layer from the base fiber layer by pulling the adhesive tape, so as to test the peeling force. The test conditions are specified: a temperature from 20° C. to 25° C., and a relative humidity from 40% to 70%.

Test method for the contact angle of the electrolyte: the electrolyte is vertically dropped on the surface of the collector, and the contact angle between the droplet and the surface of the material is measured by a contact angle measuring meter. The temperature is from 20° C. to 25° C., and the relative humidity is from 40% to 70%. The electrolyte is ethylene carbonate.

Test method for the electrical resistivity: the length and the sectional area of a sample of the current collector are recorded, the current collector sample is place in the test fixture and make sure that the fixture is in good contact with the sample surface, and a certain amount of current is applied by a resistivity tester the voltage across the sample is measured using a voltmeter. The electrical resistivity of the sample is calculated from the measured current and voltage values using the resistivity formula. The test conditions are specified: a temperature from 20° C. to 25° C., a relative humidity from 40% to 70%, and a resistance distance of a resistivity tester from 0.8 mm to 1.2 mm.

TABLE 1

| | | | Electrolyte | |
|---|---|---|---|---|
| | Tensile | Peeling | contact angle | Resistivity |
| Groups | elongation/(%) | force/N | (°) | (Ω · m) |
| Example 1 | 0.32 | 3.0 | 75 | 3.2 × 10⁻⁸ |
| Example 2 | 0.35 | 2.8 | 73 | 2.3 × 10⁻⁸ |
| Example 3 | 0.21 | 2.6 | 70 | 3.4 × 10⁻⁸ |
| Example 4 | 0.23 | 2.5 | 68 | 2.5 × 10⁻⁸ |
| Example 5 | 0.41 | 2.1 | 78 | 3.5 × 10⁻⁸ |
| Example 6 | 0.43 | 1.8 | 77 | 2.6 × 10⁻⁸ |
| Example 7 | 0.35 | 2.2 | 76 | 3.6 × 10⁻⁸ |
| Example 8 | 0.35 | 3.3 | 73 | 3.7 × 10⁻⁸ |
| Example 9 | 0.42 | 3.1 | 76 | 2.8 × 10⁻⁸ |
| Example 10 | 0.32 | 3.2 | 72 | 3.4 × 10⁻⁸ |
| Example 11 | 0.33 | 2.8 | 74 | 2.9 × 10⁻⁸ |
| Example 12 | 0.37 | 2.7 | 71 | 1.9 × 10⁻⁸ |
| Example 13 | 0.28 | 2.7 | 74 | 3 × 10⁻⁸ |
| Example 14 | 0.32 | 2.5 | 70 | 2.1 × 10⁻⁸ |
| Comparative | 0.62 | 1.1 | 82 | 3.8 × 10⁻⁸ |
| Example 1 | | | | |
| Comparative | 0.66 | 1.3 | 80 | 3 × 10⁻⁸ |
| Example 2 | | | | |
| Comparative | 0.71 | 1.4 | 79 | 3.7 × 10⁻⁸ |
| Example 3 | | | | |
| Comparative | 0.33 | 0.8 | 72 | 3.9 × 10⁻⁸ |
| Example 4 | | | | |

The technical features of the above-described embodiments may be arbitrarily combined. For the sake of brevity, not all possible combinations of the technical features in the above-described embodiments are described. However, as long as there is no contradiction between the combinations of these technical features, they should all be considered to be within the scope of this specification.

The above-described embodiments are merely illustrative of several embodiments of the present application, and the description thereof is relatively specific and detailed, but is not to be construed as limiting the scope of the application. It should be noted that a plurality of variations and modifications may be made by those skilled in the art without departing from the spirit and scope of the application. Therefore, the scope of the application should be determined by the appended claims.

1. A current collector, comprising a fiber base layer, wherein a first bonding layer and a second bonding layer are respectively arranged on surfaces on two sides of the fiber base layer, wherein a first metal layer and a second metal layer are respectively arranged on the surfaces of the first bonding layer and the second bonding layer away from the fiber base layer, and wherein the material composition of the fiber base layer comprises the following components in parts by weight:
50-120 parts of composite fibers, 4.1-19 parts of inorganic fillers, and an auxiliary agent, wherein the composite fibers comprise organic fibers and inorganic fibers.

2. The current collector according to claim 1, wherein a mass ratio of the organic fibers to the inorganic fibers is (70-99.9):(0.1-30).

3. The current collector according to claim 2, wherein a mass ratio of the organic fibers to the inorganic fibers is (90-99.9):(0.1-10).

4. The current collector according to claim 1, wherein the inorganic fillers comprise one or more selected from calcium carbonate, borax and nano-silicon dioxide; and/or
wherein the organic fibers comprise one or more selected from polyethylene terephthalate fibers, polybutylene terephthalate fibers, polyethylene naphthalate fibers, polypropyl carbamate fibers, polyurethane fibers, polycaprolactone fibers, nylon 6, nylon 66, polyimide fibers, polyacrylonitrile fibers, polyoxyethylene fibers, polyvinyl alcohol fibers, polyvinyl chloride fibers, polyvinylpyrrolidone fibers, cellulose acetate, ethyl cyanoethyl cellulose, polyaniline fibers, and polybenzoimidazole fibers; and/or
wherein the inorganic fibers comprise one or more selected from graphene fibers, carbon fibers, glass fibers, ceramic fibers, metal oxide nanofibers, and silicon dioxide nanofibers.

5. The current collector according to claim 1, wherein the auxiliary agent comprises one or more selected from a dispersant, a thickener, an emulsifier, and a binder;
wherein the dispersant comprises one or more selected from polyacrylamide, polyvinyl alcohol, sodium citrate, and sodium silicon dioxidete;
wherein the thickener comprises one or more selected from sodium hydroxypropyl methylcellulose, sodium hydroxyethyl methylcellulose, sodium carboxymethylcellulose, sodium methylcellulose and sodium alginate;
wherein the emulsifier comprises one or more selected from glyceryl monostearate, polyoxyethylene ether and sodium dodecyl sulfate; and
wherein the binder comprises sodium carboxymethylcellulose and/or polyvinyl alcohol.

6. The current collector according to claim 5, wherein the amount of the auxiliary agent added into the fiber base layer is 8.1-28 parts by weight; wherein, in the auxiliary agent, the dispersant is 2.5-9 parts by weight, the thickener is 3-8 parts by weight, the emulsifier is 0.1-2 parts by weight, and the binder is 2.5-9 parts by weight.

7. The current collector according claim 1, further comprising a first antioxidant layer and a second antioxidant layer, wherein the first antioxidant layer is located on a surface of the first metal layer away from the first bonding layer, the second antioxidant layer is located on a surface of the second metal layer away from the second bonding layer, a material of the first antioxidant layer and the second antioxidant layer is each independently selected from Al, Fe, Ni, Zn, Gr, Fe₂O₃, Al₂O₃, SiC, and Si₃N₄.

8. The current collector according to claim 1, wherein a material of the first bonding layer and the second bonding layer is each independently selected from Ni, Zn, Fe, Gr, SiO₂, Al₂O₃, Fe₂O₃, and Si₃N₄; and/or
wherein a material of the first metal layer and the second metal layer is each independently Al or Cu.

9. The current collector according to claim 8, wherein a thickness of the fiber base layer is in a range of 2 μm to 8 μm; and/or
a thickness of the first bonding layer and the second bonding layer is each independently in a range of 10 nm to 200 nm;
a thickness of the first metal layer and the second metal layer is each independently in a range of 100 nm to 2000 nm; and/or
a thickness of the first antioxidant layer and the second antioxidant layer is each independently in a range of 10 nm to 100 nm.

10. The current collector according to claim 1, wherein a material of at least one of the first bonding layer and the second bonding layer is Fe, and the inorganic fibers comprise one or both of graphene fibers and carbon fibers.

11. The current collector according to claim 1, wherein the inorganic fibers are selected from metal oxide nanofibers, a material of the first bonding layer and the second bonding layer is each independently selected from metal or metallic oxides.

12. The current collector according to claim 1, wherein the inorganic fibers are one or more selected from graphene fibers, carbon fibers, glass fibers, ceramic fibers, and silicon dioxide nanofibers, and a material of the first bonding layer and the second bonding layer is each independently selected from non-metallic oxides and non-metallic nitrides.

13. A preparation method of a current collector according to claim 1, comprising following steps:
mixing the composite fibers, the inorganic fillers and the auxiliary agent and then rolling them into shape to prepare the fiber base layer;
forming the first bonding layer and the second bonding layer on two sides of the fiber base layer, respectively; and
forming the first metal layer and the second metal layer on sides of the first bonding layer and the second bonding layer away from the fiber base layer, respectively.

14. An electrode plate, comprising the current collector according to claim 1 and an electrode active material layer on a surface of the current collector.

15. A battery cell, comprising the electrode plate according to claim 14.

16. A battery set, comprising a plurality of the battery cells according to claim 15.

17. An electrical device, comprising the battery cell according to claim 15.
